(19) United States
(12) Patent Application Publication
(10) Pub. No.: US 2011/0009110 A1
(43) Pub. Date: Jan. 13, 2011

(54) PROCESSING METHOD, SYSTEM AND APPARATUS FOR COMPONENT INSTALLATION

(76) Inventors: Haitao Liu, Shenzhen (CN); Rui Wang, Shenzhen (CN)

Correspondence Address: Huawei/BHGL, P.O. Box 10395, Chicago, IL, 60610, US

(21) Appl. No.: 12/887,266

(22) Filed: Sep. 21, 2010

Related U.S. Application Data
(63) Continuation of application No. PCT/CN2009/070821, filed on Mar. 17, 2009.

(30) Foreign Application Priority Data
Apr. 3, 2008 (CN) 200810089722.3

(51) Int. Cl. H04W 4/00; H04W 88/02

(52) U.S. Cl. 455/418; 455/550.1

(57) ABSTRACT

A processing method, a system, and an apparatus for component installation are disclosed herein. The processing method includes: receiving a component from a server; and determining operations to be performed on the received component according to state information set for a removed component or information about the removed component. After the component is removed, the state information of the removed component or information about the component is set and stored, and the operations to be performed on a subsequent component are determined accordingly, thus preventing repeated installation of the removed component. Moreover, a deadline of storing the removed component information is set so that the information about the component can be removed automatically upon arrival of the deadline.

### CROSS-REFERENCE TO RELATED APPLICATIONS

This application is a continuation of International Application No. PCT/CN2009/070821, filed on Mar. 17, 2009, which claims priority to Chinese Patent Application No. 200810089722.3, filed on Apr. 3, 2008, both of which are hereby incorporated by reference in their entireties.

### FIELD OF THE DISCLOSURE

The present disclosure relates to communication technologies, and in particular, to a processing method, a system, and an apparatus for component installation.

### BACKGROUND OF THE DISCLOSURE

Open Mobile Alliance (OMA) Device Management (DM) V1.2 (as referred to “DM Specifications” hereinafter) is unified device management specifications developed by the OMA. It defines the functions of remote management on a destination terminal. The DM system provides a cost-efficient solution, through which a third party can manage and set the environment and configuration information in a wireless network terminal device (such as mobile terminal and functional objects in the terminal), and solve the problems in the using such network devices. In this solution, software and firmware are installed and upgraded in an Over The Air (OTA) mode, and therefore, more personalized and individualized services are provided, and the user experience is improved. The third party may be a mobile operator, Service Provider (SP), or an information management department of a partner.

With development of wireless communication applications, terminals become indispensable tools in the life of people, and people impose higher and higher requirements on the look-and-feel style of terminals. A Service Provider (SP) server expects to provide diversified look-and-feel styles for users so that the users can display the look-and-feel styles of their terminals in a personalized way. The SP server also expects to manage the Look-and-Feel Customization (LFC) package on the terminal for the benefit of the users and the SP server. Look-and-feel of a terminal refers to the contents presented by the terminal to the outside, for example, background, ring tone, and menu, which are known as look-and-feel elements. When multiple look-and-feel elements are provided for the terminal or operated by the terminal concurrently, the set of such elements is called a LFC package.

In a solution to customizing look-and-feel styles remotely based on OMA DM in the prior art, every element of the LFC package is managed. When the network delivers the look-and-feel contents, it changes the contents on the corresponding node directly.

In the process of developing the present disclosure, the inventor finds at least the following defects in the prior art:

When the software or LFC package is removed on the terminal, the node corresponding to the LFC package or the node corresponding to the software under “Deployed” is also removed. The SP server checks the installation state of the components on the terminal periodically. Consequently, even if a component has been removed by the user, the server would request re-installing the component again after the checking. The prior art provides no solution to this problem.

### SUMMARY OF THE DISCLOSURE

The embodiments of the present disclosure provide a processing method, a system, and an apparatus for component installation in order to prevent an SP server from downloading or installing a component repeatedly on the same terminal.

To fulfill the foregoing objectives, one aspect of the present disclosure is to provide a processing method for component installation. The processing method includes: receiving a component from a server; and determining operations to be performed on the received component according to state information set for a removed component or information about the removed component.

Another aspect of the present disclosure is to provide a processing method for component installation. The processing method includes: querying and obtaining state information of a removed component or information about the removed component, where the information is set by a terminal; and determining operations to be performed on a subsequent component according to the state information of the removed component or the information about the removed component.

Another aspect of the present disclosure is to provide a system for component installation. The system includes: a terminal and a server. The terminal is configured to: receive a component delivered by a server, set and store state information of a removed component or information about the component, and determine operations to be performed on the delivered component according to the state information of the component or the information about the component. The server is configured to: query and obtain the state information of the removed component or the information about the removed component, where the information is set by the terminal; and determine operations to be performed on a subsequent component according to the state information of the removed component or the information about the removed component.

Another aspect of the present disclosure is to provide a terminal that includes: a receiving module configured to receive a component delivered by a server; a setting module configured to set and store state information of a removed component or information about the component; and an operation determining module configured to determine operations to be performed on the component received by the receiving module according to the component state information or component information set by the setting module.

Another aspect of the present disclosure is to provide a server that includes: a querying and obtaining module configured to query and obtain state information of a removed component or information about the removed component, where the information is set by a terminal; and an operation determining module configured to determine operations to be performed for a subsequent component according to the state information of the removed component or the information about the removed component, where the information is obtained by the querying and obtaining module.

Compared with the prior art, the embodiments of the present disclosure bring in at least the following benefits: After the component is removed, the state information of the removed component or information about the component is set and stored, and the operations to be performed on the subsequent component are determined accordingly, thus preventing repeated download or installation of the removed component.

### BRIEF DESCRIPTION OF THE DRAWINGS

FIG. 1 is a flowchart of a processing method for component installation in an embodiment of the present disclosure;

FIG. 2 shows a structure of a Software Component Management Object (SCOMO) management subtree in the first embodiment of the present disclosure;

FIG. 3 is a flowchart of another processing method for component installation in an embodiment of the present disclosure;

FIG. 4 shows how an SP server queries a terminal in the first embodiment of the present disclosure;

FIG. 5 shows a structure of a Removed subtree in the second embodiment of the present disclosure;

FIG. 6 shows how an SP server queries a terminal in the second embodiment of the present disclosure;

FIG. 7 shows a structure of an LFC management subtree in the third embodiment of the present disclosure;

FIG. 8 shows how an SP server queries a terminal in the third embodiment of the present disclosure;

FIG. 9 shows a structure of a Removed subtree in the fourth embodiment of the present disclosure;

FIG. 10 shows how an SP server queries a terminal in the fourth embodiment of the present disclosure;

FIG. 11 shows a system for component installation in an embodiment of the present disclosure;

FIG. 12 shows a structure of a terminal in an embodiment of the present disclosure; and

FIG. 13 shows a structure of a server in an embodiment of the present disclosure.

### DETAILED DESCRIPTION OF THE EMBODIMENTS

The embodiments of the present disclosure provide a processing method for component installation. When an installed component is removed on the terminal, the state information of the component or information about the component is set and stored, and the operations to be performed on the subsequent component are determined accordingly. In this way, the information about the component is still stored on the corresponding management subtree, and repeated download or installation of the removed component is avoided, and information about the component may be removed automatically upon a deadline when the deadline of storing the information is set.

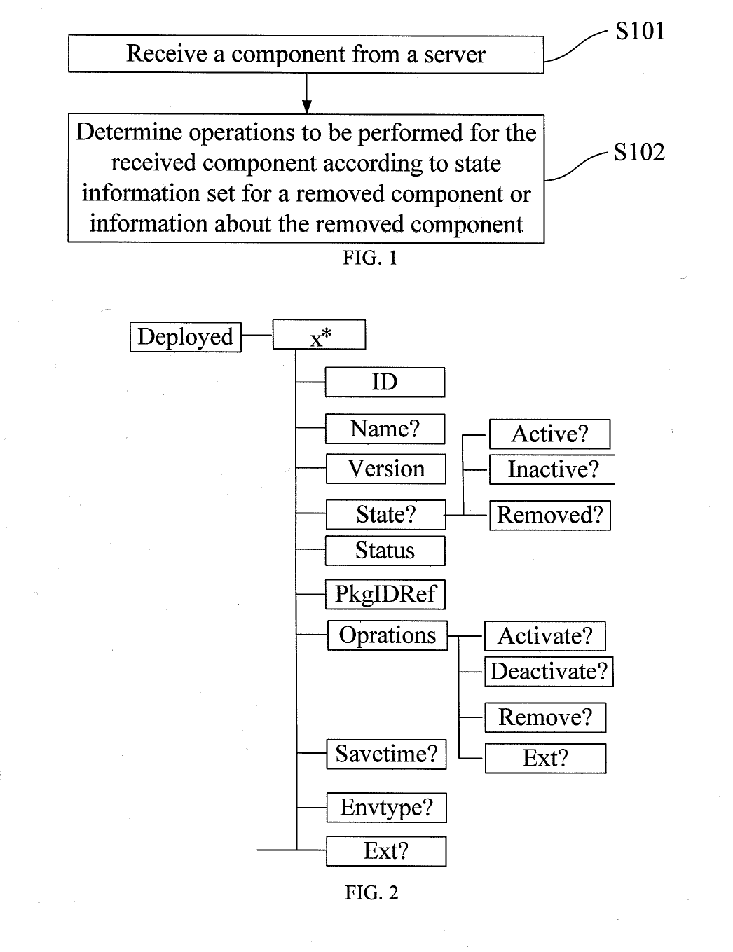

FIG. 1 is a flowchart of a processing method for component installation in an embodiment of the present disclosure. The processing method includes the following steps:

Step S101: Receive a component from a server.

Step S102: Determine operations to be performed on the received component according to state information set for a removed component or information about the removed component. After a component is removed, the state information of the removed component or the information about the removed component is set and stored. The state information of the component may be set to “removed”, indicating that the component is removed.

The information about the component includes the version of the component and the deadline of storing the component information, and includes at least one of the identifier of the component and the name of the component. The information about the component is set in the component management object.

After the state information of the component or the information about the component is set, the terminal compares the version of the delivered component with the version of the currently installed component when the SP server delivers a component identical to the removed component to the terminal again. If the version is the same, the terminal determines whether the deadline of storing the component information is the same as the current time through comparison, and if the deadline of storing the component information is different from the current time, it indicates that the deadline of storing the component information has not arrived and the terminal keeps storing the component information in the component management object. If the version of the removed component is different from the version of the delivered component, the terminal may:

(1) decide not to install the component delivered by the server; or

(2) decide to install the component delivered by the server; or

(3) decide whether to install the component delivered by the server according to a preset policy.

If the component re-delivered by the SP server to the terminal is different from the removed component, the terminal may install the delivered component.

Through the processing method for component installation above, when a component is removed, the state information of the component or the information about the component is set and stored, and the operations to be performed on the component delivered by the server are determined accordingly. Since the information about the removed component is still stored on the component management object, and repeated download or installation of the removed component on the terminal is avoided effectively, and terminal may remove the information about the component automatically upon a deadline when the deadline of storing the information about the removed component is set.

FIG. 2 shows a structure of a Software Component Management Object (SCOMO) management subtree in the first embodiment of the present disclosure. In the existing SCOMO management subtree, the terminal adds a “Removed” state value in the “Deployed/<X>/State” node, as shown in Table 1:

TABLE 1

| State | Description | Integer value |
|---|---|---|
| Inactive | The installed software is inactive | 10 |
| Active | The installed software is active | 20 |
| Removed | The software is removed | 30 |

Meanwhile, a Savetime node is added in the existing SCOMO management subtree to specify the deadline of storing the Removed instruction information. By default, the Savetime is set to 19000101. Table 2 shows the Removed instruction information.

TABLE 2

| State | Tree Occurrence | Format | Minimum access type |
|---|---|---|---|
| REQUIRED | ZeroOrOne | Date | Get |

When removing the software, the terminal does not remove the management subtree under “Deployed”, but sets the State node to “Removed”, indicating that the software is removed; and sets the value of the Savetime node. The terminal stores the information about the removed software, for example, version, identifier and name of the software, and deadline of storing the software information, etc.

It is assumed that the server of SP A installed a new software “GameA” for the terminal of user B a few days ago, the terminal instantiates the <x*> node under the Deployed node of the Management Object (MO) management tree shown in FIG. 2 to “GameA Component”, and assigns a value to the node thereunder. User B has a poor experience of using the software, so the terminal removes the software.

At this time, the GameA Component subtree shown in FIG. 2 still exists, and the terminal sets the value of the State node to 30 (Removed). Meanwhile, the value of the Savetime node is specified by the terminal, or received by the terminal from the server. Here it is assumed that the value of the Savetime node is 20081230.

When the terminal of user B receives the software re-delivered by the SP server, the terminal compares the version of the delivered software with the version of the removed software. If the versions are the same, the terminal does not install the delivered software. Further, the terminal determines whether the deadline of storing the information about the removed software is the same with the current time through comparison. If the deadline of storing the information about the removed software is set to 2008-12-30 and the deadline of storing the information about the removed software is different from the current time (supposing that the current time is 2008-12-01), the terminal keeps storing the information about the removed software.

If the terminal finds that the delivered software is different from the removed software, or the version of the removed software is different from the version of the delivered software, the terminal may choose to install or not to install the software delivered by the server, or the terminal decides whether to install the software delivered by the server according to a preset policy.

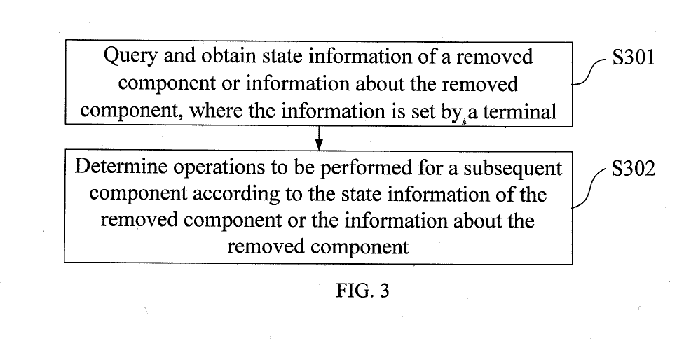

FIG. 3 is a flowchart of another processing method for component installation in an embodiment of the present disclosure. The processing method includes the following steps:

Step S301: Query and obtain state information of a removed component or information about the removed component, where the information is set by a terminal.

After the component is removed, the terminal sets and stores the state information of the removed component or the information about the removed component. When querying the terminal, the SP server obtains the state information of the removed component or the information about the removed component.

Step S302: Determine operations to be performed on a subsequent component according to the state information of the removed component or the information about the removed component. If the subsequent component is different from the removed component, or, if the subsequent component is the same as the removed component but the version of the subsequent component is different from the version of the removed component, the SP server recommends the terminal that the subsequent component be installed.

If the version of the subsequent component is the same as the version of the removed component but the deadline of storing the information about the removed component is different from the current time, the SP server keeps storing the information about the removed component.

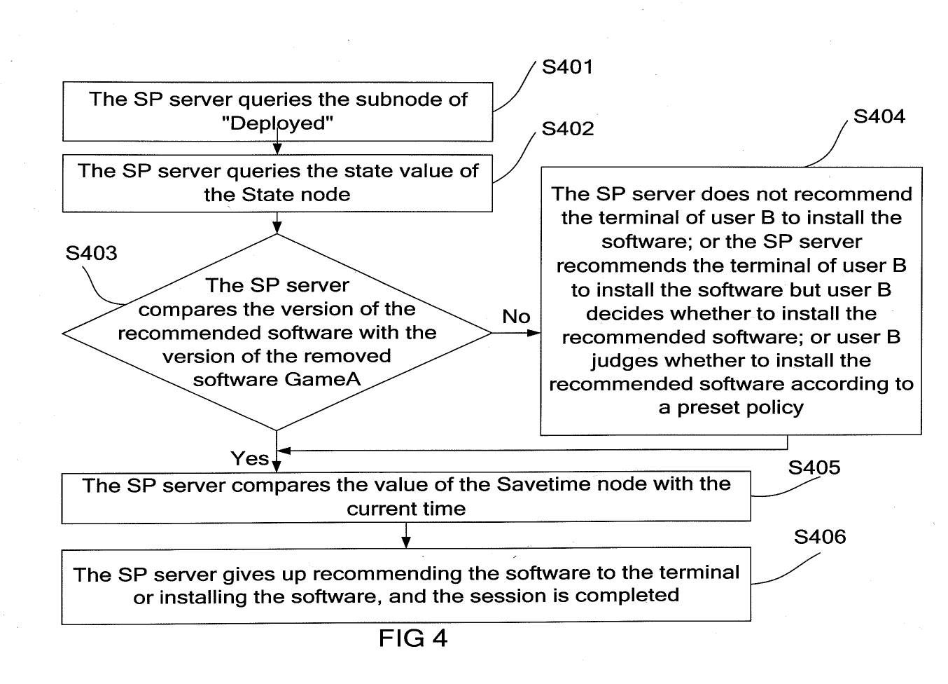

Continue referring to FIG. 2, if user B is not satisfied with the GameA software provided by the server of SP A, the terminal removes it. Supposing that the SP server queries the terminal one month later, the SP server performs the process shown in FIG. 4, including:

Step S401: The SP server queries the subnode of “Deployed” and finds a relevant subtree of GameA software—“GameA Component”.

Step S402: Through querying, the SP server finds that the state value of the State node is 30, and proceeds to step S403.

Step S403: The SP server compares the version of the recommended software with the version of the removed GameA software. If the versions are the same, the SP server performs step S405; if the version of the recommended software is different from the version of the removed GameA software, the SP server performs step S404.

Step S404: The SP server does not recommend the terminal of user B that the recommended software be installed; or the SP server recommends the terminal of user B that the software be installed, but user B decides whether to install the recommended software; or user B judges whether to install the recommended software according to a preset policy. If the terminal does not install the recommended software, the process proceeds to step S405.

Step S405: The SP server compares the value of the Savetime node (20081230) with the current time (for example, 20070910), and finds that the deadline of storing the information has not arrived. Therefore, the SP server keeps storing the “GameA Component” management subtree on the SCOMO management tree.

Step S406: The SP server gives up recommending the software to the terminal or installing the software, and the session is completed.

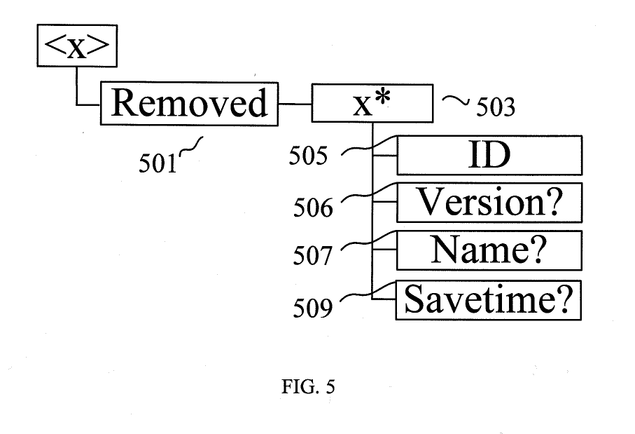

FIG. 5 shows a structure of a Removed subtree in the second embodiment of the present disclosure. In the terminal in the second embodiment, a Removed subtree is added in the existing SCOMO management subtree. The nodes of the Removed subtree are described below:

<X>/Removed501

| State | Tree Occurrence | Format | Minimum access type |
|---|---|---|---|
| REQUIRED | One | Node | Get |

This node is a parent node of all removed software information.

<X>/Removed/<X>503

| State | Tree Occurrence | Format | Minimum access type |
|---|---|---|---|
| REQUIRED | ZeroOrMore | Node | Get |

This node is a placeholder of removed software in the terminal.

<X>/Removed/<X>/ID505

| State | Tree Occurrence | Format | Minimum access type |
|---|---|---|---|
| REQUIRED | One | Chr | Get |

This node is a leaf node, which specifies the ID of the removed software in the terminal and uniquely identifies this software. Its value is the same as the value in the corresponding Deployed/<X>/ID.

<X>/Removed/<X>/Version506

| State | Tree Occurrence | Format | Minimum access type |
|---|---|---|---|
| REQUIRED | One | Chr | Get |

This node is a leaf node, and specifies the version of the removed software in the terminal. Its value is the same as the value in the corresponding Deployed/<X>/Version.

<X>/Removed/<X>/Name507

| State | Tree Occurrence | Format | Minimum access type |
|---|---|---|---|
| OPTIONAL | ZeroOrOne | Chr | Get |

This node is a leaf node, and specifies the name of the removed software in the terminal. Its value is the same as the value in the corresponding Deployed/<X>/Name.

<X>Removed/<X>/Savetime509

| State | Tree Occurrence | Format | Minimum access type |
|---|---|---|---|
| REQUIRED | ZeroOrOne | Date | Get |

This node is a leaf node, and specifies a deadline of storing Deployed/Removed/<X> to avoid permanent storage of futile information. Its value is 19000101 by default.

When removing the software, the terminal also removes the corresponding management subtree under “Deployed”, creates the corresponding software installation processing subtree under “Removed”, and sets the corresponding value.

It is assumed that the server of SP A installed a new software “GameA” for the terminal of user B a few days ago, the terminal instantiates the <x*> node under the Deployed node of the MO management tree shown in FIG. 2 to “GameA Component”, and assigns a value to the node under it. User B has a poor experience of using the software, so the terminal removes the software.

In this case, the GameA Component management subtree shown in FIG. 2 is also removed, and a GameA Removed subtree is created under the Removed node shown in FIG. 5. The values of ID, Name, and Version are the same as the corresponding values under the GameA Component node under the removed Deployed node. The value of the Savetime node is specified by the terminal, or received by the terminal from the server. Here it is assumed that the value of Savetime is 20081230.

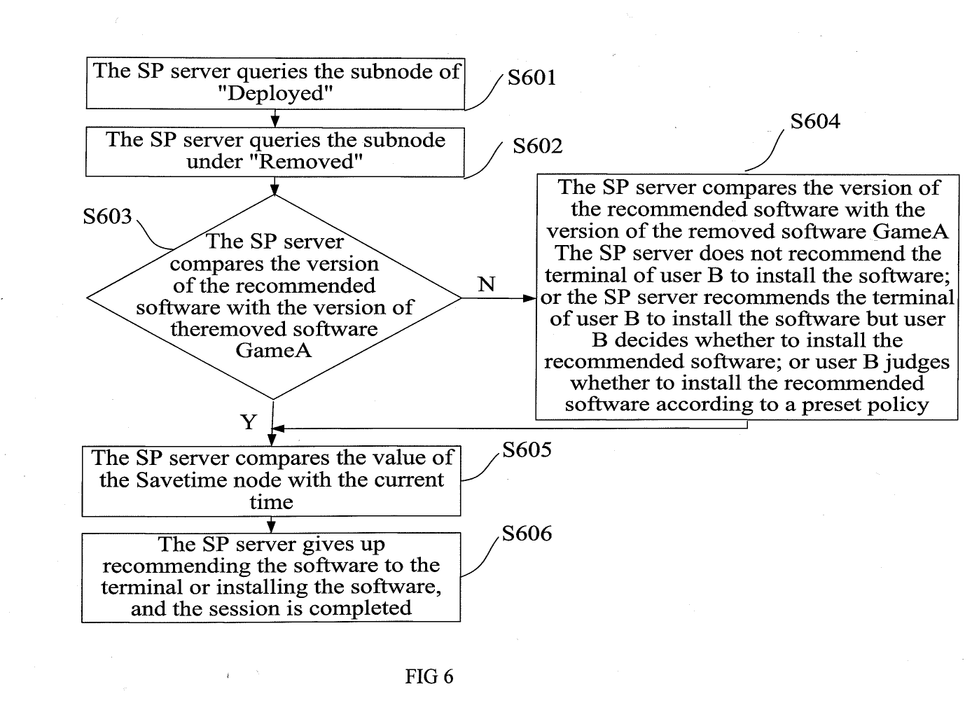

Supposing that the SP server queries the terminal one month later, the SP server performs the process shown in FIG. 6, including:

Step S601: The SP server queries the subnode of “Deployed” and finds no relevant subtree of GameA software.

Step S602: The SP server queries the subnode under “Removed” and finds a relevant subtree of GameA software—“GameA Removed”.

Step S603: The SP server compares the version of the recommended software with the version of the removed GameA software. If the version is the same, the SP server performs step S605; if the version of the recommended software is different from the version of the removed GameA software, the SP server performs step S604.

Step S604: The SP server does not recommend the terminal of user B that the software be installed; or the SP server recommends the terminal of user B that the software be installed but user B decides whether to install the recommended software; or user B judges whether to install the recommended software according to a preset policy. If the terminal does not install the recommended software, the process proceeds to step S605.

Step S605: The SP server compares the value of the Savetime node (20081230) with the current time (for example, 20070910), and finds that the deadline of storing the information has not arrived. Therefore, the SP server keeps storing the “GameA Removed” subtree.

Step S606: The SP server gives up recommending the software to the terminal or installing the software, and the session is completed.

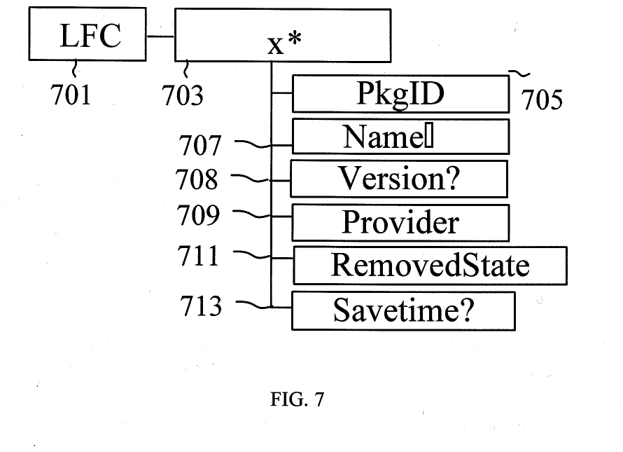

FIG. 7 shows a structure of an LFC management subtree in the third embodiment of the present disclosure. In the third embodiment, a RemovedState node and a Savetime node are added in the existing LFC management subtree. The nodes are described below:

LFC Package701

| State | Tree Occurrence | Format | Minimum access type |
|---|---|---|---|
| REQUIRED | One | Node | Get |

This node is a parent node of all LFC packages on the terminal.

LFC Package/<X>703

| State | Tree Occurrence | Format | Minimum access type |
|---|---|---|---|
| REQUIRED | ZeroOrMore | Node | Get |

This node is a placeholder of the LFC package in the terminal.

LFC Package/<X>/PkgID705

| State | Tree Occurrence | Format | Minimum access type |
|---|---|---|---|
| REQUIRED | One | Chr | Get |

This node is a leaf node, which specifies the ID of the LFC package in the terminal and uniquely identifies the LFC package.

LFC Package/<X>/Name707

| State | Tree Occurrence | Format | Minimum access type |
|---|---|---|---|
| OPTIONAL | ZeroOrOne | Chr | Get |

This node is a leaf node, which specifies the name of the LFC package in the terminal.

LFC Package/<X>/Version708

| State | Tree Occurrence | Format | Minimum access type |
|---|---|---|---|
| REQUIRED | One | Chr | Get |

This node is a leaf node, which specifies the version of the LFC package in the terminal.

LFC Package/<X>/Provider709

| State | Tree Occurrence | Format | Minimum access type |
|---|---|---|---|
| OPTIONA | ZeroOrOne | Chr | Get |

This node is a leaf node, which specifies the provider of the LFC package in the terminal.

LFC Package/<X>/RemovedState711

| State | Tree Occurrence | Format | Minimum access type |
|---|---|---|---|
| REQUIRED | One | Bool | Get |

This node is a leaf node, indicating whether the LFC package in the terminal is removed. The value “1” indicates that the LFC package is removed, and “0” indicates that the LFC package is not removed. By default, the value of this node is “0”. This node is a new node added on the LFC management subtree in an embodiment of the present disclosure.

<X>/Removed/<X>/Savetime713

| State | Tree Occurrence | Format | Minimum access type |
|---|---|---|---|
| REQUIRED | ZeroOrOne | Date | Get |

This node is a leaf node, and specifies a deadline of storing the LFC package information to avoid permanent storage of futile information. Its value is 19000101 by default.

When removing the LFC package, the terminal does not remove the corresponding management subtree, but sets the state of the RemovedState node to “1” and sets the value of the Savetime node.

It is assumed that the server of SP A installed a new LFC package A for the terminal of user B a few days ago. The terminal instantiates the <x*> node under the LFC management subtree shown in FIG. 7 to “LFC Package A”, and assigns a value to the node under it. User B has a poor experience of using the software, so the terminal removes the LFC package.

At this time, the LFC Package subtree shown in FIG. 7 still exists, and the terminal sets the value of the RemoveState node to 1, indicating that the LFC package is removed. Meanwhile, the value of the Savetime is specified by the terminal, or received by the terminal from the server. Here it is assumed that the value of the Savetime node is 20081230.

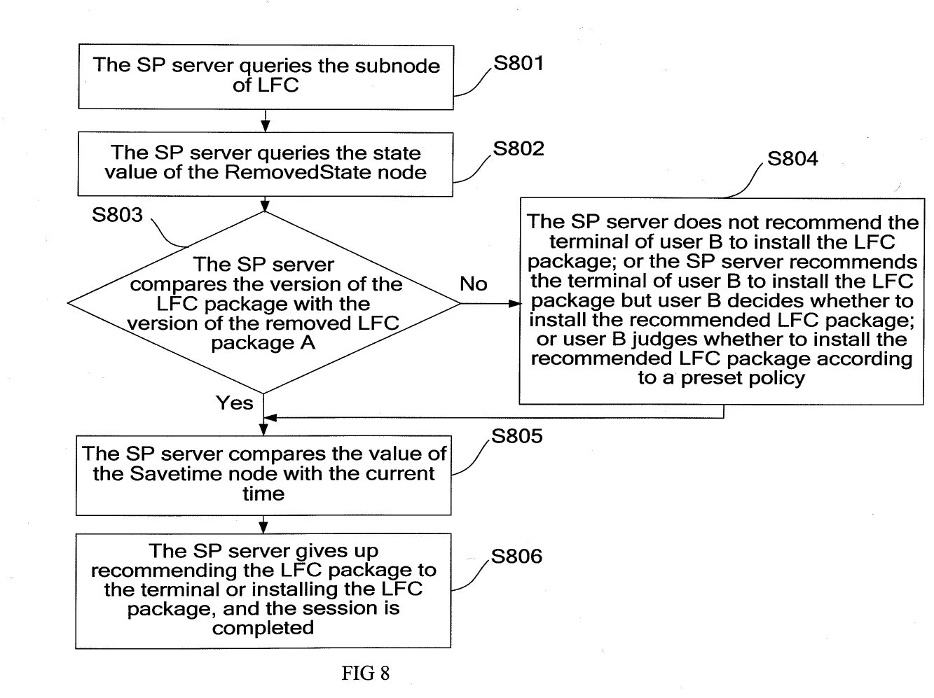

Assuming that the SP server queries the terminal one month later, the SP server performs the process shown in FIG. 8, including:

Step S801: The SP server queries the subnode of LFC and finds a relevant subtree of LFC Package A—“LFC Package A”.

Step S802: Through querying, the SP server finds that the state value of the RemovedState node is 1, and proceeds to step S803.

Step S803: The SP server compares the version of the recommended LFC package with the version of the removed LFC package A. If the version is the same, the SP server performs step S805; if the version of the recommended LFC package is different from the version of the removed LFC package A, the SP server performs step S804.

Step S804: The SP server does not recommend the terminal of user B that the LFC package be installed; or the SP server recommends the terminal of user B that the LFC package be installed but user B decides whether to install the recommended LFC package; or user B judges whether to install the recommended LFC package according to a preset policy. If the terminal does not install the recommended LFC package, the process proceeds to step S805.

Step S805: The SP server compares the value of the Savetime node (20081230) with the current time (for example, 20070910), and finds that the deadline of storing the information has not arrived. Therefore, the SP server keeps storing the “LFC Package A” management subtree.

Step S806: The SP server gives up recommending the LFC package to the terminal or installing the LFC package, and the session is completed.

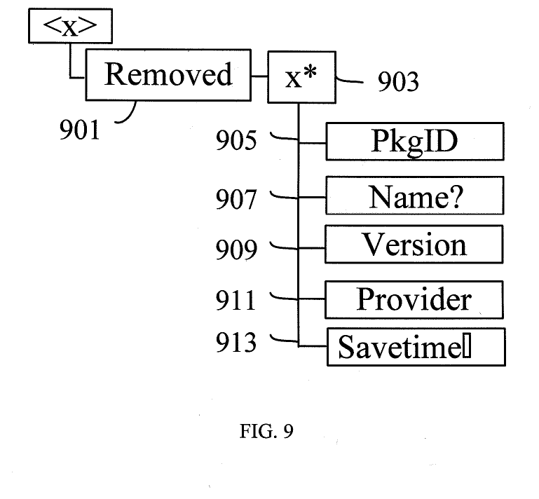

FIG. 9 shows a structure of a Removed subtree in the fourth embodiment of the present disclosure. In the terminal in the fourth embodiment, a Removed subtree is added in the existing LFC management subtree. The nodes of the Removed subtree are described below:

<X>/Removed901

| State | Tree Occurrence | Format | Minimum access type |
|---|---|---|---|
| REQUIRED | One | Node | Get |

This node is a parent node of all removed LFC package information.

<X>/Removed/<X>903

| State | Tree Occurrence | Format | Minimum access type |
|---|---|---|---|
| REQUIRED | ZeroOrMore | Node | Get |

This node is a placeholder of the removed LFC package in the terminal.

LFC Package/<X>/PkgID905

| State | Tree Occurrence | Format | Minimum access type |
|---|---|---|---|
| REQUIRED | One | Chr | Get |

This node is a leaf node, which specifies the ID of the LFC package in the terminal and uniquely identifies the LFC package.

LFC Package/<X>/Name907

| State | Tree Occurrence | Format | Minimum access type |
|---|---|---|---|
| OPTIONAL | ZeroOrOne | Chr | Get |

This node is a leaf node, which specifies the name of the LFC package in the terminal.

LFC Package/<X>/Version909

| State | Tree Occurrence | Format | Minimum access type |
|---|---|---|---|
| REQUIRED | One | Chr | Get |

This node is a leaf node, which specifies the version of the LFC package in the terminal.

LFC Package/<X>/Provider911

| State | Tree Occurrence | Format | Minimum access type |
|---|---|---|---|
| OPTIONAL | ZeroOrOne | Chr | Get |

This node is a leaf node, which specifies the provider of the LFC package in the terminal.

<X>/Removed/<X>/Savetime913

| State | Tree Occurrence | Format | Minimum access type |
|---|---|---|---|
| REQUIRED | ZeroOrOne | Date | Get |

This node is a leaf node, and specifies a deadline of storing the LFC package to avoid permanent storage of futile information. Its value is 19000101 by default.

When removing the LFC package, the terminal also removes the corresponding management subtree, creates the corresponding removed LFC package management subtree under “Removed”, and sets the corresponding value.

It is assumed that the server of SP A installed a new LFC package A for the terminal of user B a few days ago. The terminal instantiates the <x*> node under the LFC management subtree show in FIG. 7 to “LFC Package A”, and assigns a value to the node under it. User B has a poor experience of using the software, so the terminal removes the LFC package.

In this case, the LFC Package A management subtree corresponding to Package A shown in FIG. 7 is also removed, and a Package A Removed subtree is created under the Removed node shown in FIG. 9. The values of ID, Name, and Version are the same as the corresponding values under the removed LFC Package A management subtree. The value of the Savetime node is specified by the terminal, or received by the terminal from the server. Here it is assumed that the value of Savetime is 20081230.

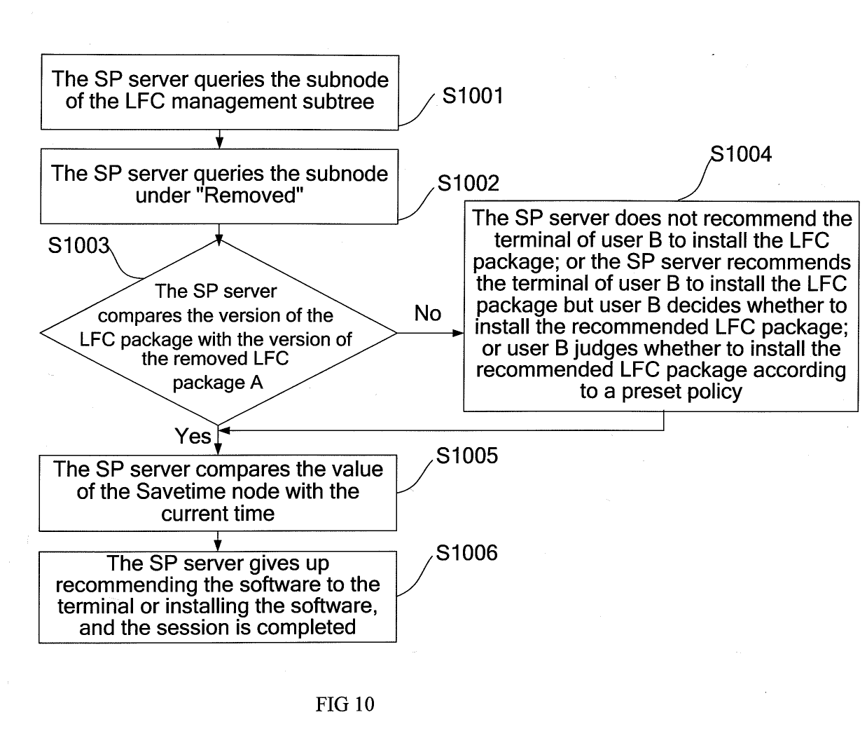

Assuming that the SP server queries the terminal one month later, the SP server performs the process shown in FIG. 10, including:

Step S1001: The SP server queries the subnode of the LFC management subtree and finds no relevant subtree corresponding to LFC Package A.

Step S1002: The SP server queries the subnode under “Removed” and finds a relevant subtree of Package A—“Package A Removed”.

Step S1003: The SP server compares the version of the recommended LFC package with the version of the removed LFC package A. If the version is the same, the SP server performs step S1005; if the version of the recommended LFC package is different from the version of the removed LFC package A, the SP server performs step S1004.

Step S1004: The SP server does not recommend the terminal of user B that the LFC package be installed; or the SP server recommends the terminal of user B that the LFC package be installed but user B decides whether to install the recommended LFC package; or user B judges, whether to install the recommended LFC package according to a preset policy. If the terminal does not install the recommended LFC package, the process proceeds to step S1005.

Step S1005: The SP server compares the value of the Savetime node (20081230) with the current time (for example, 20070910), and finds that the deadline of storing the information has not arrived. Therefore, the SP server keeps storing the “Package A Removed” subtree.

Step S1006: The SP server gives up recommending the LFC package to the terminal or installing the LFC package, and the session is completed.

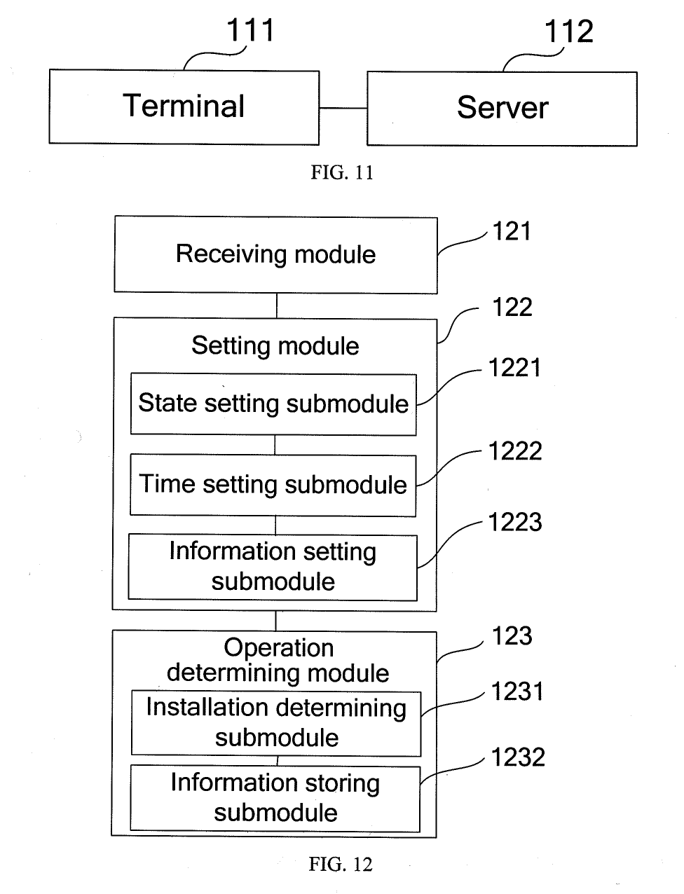

FIG. 11 shows a system for component installation in an embodiment of the present disclosure. The system includes: a terminal 111, configured to: receive a component delivered by a server 112, and determine operations to be performed on the delivered component according to state information set for a removed component or information about the removed component; and a server 112, configured to: query and obtain the state information of the removed component or the information about the removed component, where the information is set by the terminal 111; and determine operations to be performed on a subsequent component according to the state information of the removed component or the information about the removed component.

FIG. 12 shows a structure of a terminal in an embodiment of the present disclosure. The terminal includes: a receiving module 121, configured to receive a component delivered by a server; a setting module 122, configured to set and store state information of a removed component or information about the component; and an operation determining module 123, configured to determine operations to be performed on the component received by the receiving module 121 according to the component state information or component information set by the setting module 122.

The setting module 122 includes a state setting submodule 1221, configured to set the state information of the component to “removed”.

The setting module 122 further includes a time setting submodule 1222, configured to set the deadline of storing the component information after the state setting submodule 1221 sets the state information of the component to “removed”.

The setting module 122 further includes an information setting submodule 1223, configured to set the component information into a component management object.

The operation determining module 123 includes an installation determining submodule 1231, configured to: decide to install the component received by the receiving module 121 if the component received by the receiving module 121 is different from the removed component; or decide to install the component received by the receiving module 121 if the component received by the receiving module 121 is the same as the removed component but the version of the component received by the receiving module 121 is different from the version of the removed component; or decide not to install the component received by the receiving module 121; or decide whether to install the component received by the receiving module 121 according to a preset policy.

The operation determining module 123 further includes an information storing submodule 1232, configured to keep storing the information about the removed component if the component received by the receiving module 121 is the same as the removed component, the version of the component received by the receiving module 121 is the same as the version of the removed component, and the deadline of storing the information about the removed component is different from the current time.

Through the terminal described above, the setting module 122 sets the state information of the component and the information about the component, and the operation determining module 123 determines the operation to be performed on the component received by the receiving module 121 according to the information stored by the setting module 122, thus preventing the terminal from installing a component repeatedly. Moreover, a deadline of storing the removed component information is set to avoid permanent storage of the information about the removed component.

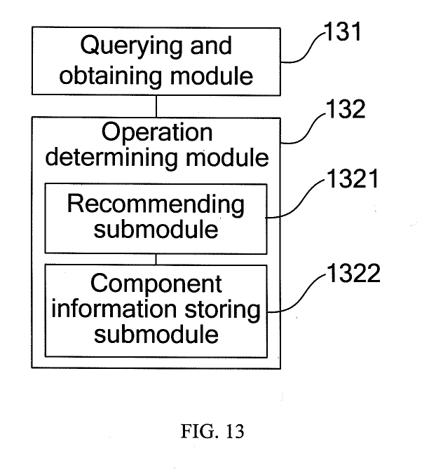

FIG. 13 shows a structure of a server in an embodiment of the present disclosure. The server includes: a querying and obtaining module 131, configured to query and obtain state information of a removed component or information about the removed component, where the information is set by a terminal; and an operation determining module 132, configured to determine operations to be performed on a subsequent component according to the state information of the removed component or the information about the removed component, where the information is obtained by the querying and obtaining module 131.

The operation determining module 132 includes a recommending submodule 1321, configured to: recommend installation of the subsequent component if the subsequent component is different from the removed component; or, if the subsequent component is the same as the removed component but the version of the subsequent component is different from the version of the removed component.

The operation determining module 132 includes a component information storing submodule 1322, configured to keep storing the information about the removed component if the version of the subsequent component is the same as the version of the removed component but the deadline of storing the information about the removed component is different from the current time.

By the server described above, the querying and obtaining module 131 obtains the state information of the removed component and the information about the removed component, where the information is set by the terminal; and the operation determining module 132 determines the operation to be performed on the subsequent component according to the information obtained by the querying and obtaining module 131, thus preventing the server from recommending the terminal that a component be installed repeatedly. Moreover, a deadline of storing the removed component information is set to avoid permanent storage of the information about the removed component.

Through the descriptions of the preceding embodiments, those skilled in the art may understand that the present disclosure may be implemented by hardware only or by software and necessary universal hardware. Based on such understandings, the present disclosure may be embodied in the form of a software product. The software product may be stored in a nonvolatile storage medium, which can be a Compact Disk Read-Only Memory (CD-ROM), Universal Serial Bus (USB) flash drive, or a removable hard drive. The software product includes a number of instructions that enable a computer device including a processor (including a personal computer, a server, or a network device) to execute the processing methods provided in the embodiments of the present disclosure.

The above descriptions are merely specific embodiments of the present disclosure, but not intended to limit the scope of the present disclosure. Any modification, equivalent replacement, or improvement made without departing from the spirit and principle of the present disclosure should fall within the scope of the present disclosure.

What is claimed is:

1. A processing method for component installation, comprising:
receiving, at a terminal, a component from a server; and
determining operations to be performed on the received component according to state information set for a removed component or information about the removed component.

2. The processing method for component installation according to claim 1, further comprising setting the state information of the removed component, wherein: the setting of the state information of the removed component comprises: keeping the management subtree corresponding to the removed component and setting the state information of the component to “removed.”

3. The processing method for component installation according to claim 2, wherein:
after setting the state information of the component to “removed,” the processing method further comprises: setting a deadline of storing the information about the component;
the determining of the operations to be performed for the received component according to the state information set for the removed component further comprises: keeping storing the information about the removed component if a version of the received component is the same as a version of the removed component but the deadline is different from current time.

4. The processing method for component installation according to claim 1, wherein:
the information about the removed component comprises version of the removed component, and comprises at least one of an identifier of the removed component and a name of the removed component; and the information about the removed component is set in a component management object when the component is removed.

5. The processing method for component installation according to claim 1, wherein: the determining of the operations to be performed on the received component according to the state information set for the removed component or the information about the removed component comprises:
if the received component is the same as the removed component but version of the received component is different from version of the removed component, deciding to install the received component, or deciding not to install the received component, or deciding whether to install the received component according to a preset policy.

6. The processing method for component installation according to claim 5, wherein: the information about the removed component further comprises a deadline of storing the information about the component;
the determining of the operations to be performed for the received component according to the information about the removed component further comprises:
keeping storing the information about the removed component if the version of the received component is the same as the version of the removed component but the deadline of storing the information about the removed component is different from current time.

7. The processing method for component installation according to claim 1, wherein: the determining of the operations to be performed for the received component according to the state information set for the removed component or the information about the removed component comprises:
installing the received component if the received component is different from the removed component.

8. A processing method for component installation, comprising:
querying and obtaining state information of a removed component or information about the removed component, wherein the information is set by a terminal; and
determining operations to be performed for a subsequent component according to the state information of the removed component or the information about the removed component.

9. The processing method for component installation according to claim 8, wherein the determining of the operations to be performed on the subsequent component according to the state information of the removed component or the information about the removed component comprises:
recommending an installation of the subsequent component if the subsequent component is the same as the removed component and a version of the subsequent component is different from a version of the removed component.

10. The processing method for component installation according to claim 9, wherein the determining of the operations to be performed on the subsequent component according to the state information of the removed component or the information about the removed component further comprises:
keeping storing the information about the removed component if the version of the subsequent component is the same as the version of the removed component and a deadline of storing the information about the removed component is different from current time.

11. The processing method for component installation according to claim 8, wherein the determining of the operations to be performed on the subsequent component according to the state information of the removed component or the information about the removed component comprises:
recommending the installation of the subsequent component if the subsequent component is different from the removed component.

12. A system for component installation, comprising:
a terminal, configured to: receive a component delivered by a server, and determine operations to be performed on the received component according to state information set for a removed component or information about the removed component; and
the server, configured to: query and obtain the state information of the removed component or the information about the removed component, wherein the information is set by the terminal, and determine operations to be performed on a subsequent component according to the state information of the removed component or the information about the removed component.

13. A terminal, comprising:
a receiving module configured to receive a component delivered by a server;
a setting module configured to set and store state information of a removed component or information about the component; and
an operation determining module configured to determine operations to be performed on the component received by the receiving module according to the state information of the component or the information about the component, wherein the information is set by the setting module.

14. The terminal according to claim 13, wherein:
the setting module comprises a state setting submodule, which is configured to set the state information of the component to “removed.”

15. The terminal according to claim 14, wherein:
the setting module further comprises a time setting submodule, which is configured to set a deadline of storing the information about the component after the state setting submodule sets the state information of the component to “removed.”

16. The terminal according to claim 13, wherein:
the setting module comprises an information setting submodule, which is configured to set the information about the component into a component management object.

17. The terminal according to claim 13, wherein the operation determining module comprises:
an installation determining submodule configured to do at least one of the following:
decide to install the component received by the receiving module if the component received by the receiving module is different from the removed component;
decide to install the component received by the receiving module if the component received by the receiving module is the same as the removed component but version of the component received by the receiving module is different from version of the removed component;
decide not to install the component received by the receiving module; and
decide whether to install the component received by the receiving module according to a preset policy.

18. The terminal according to claim 13, wherein the operation determining module further comprises:
an information storing submodule configured to keep storing the information about the removed component if the component received by the receiving module is the same as the removed component, a version of the component received by the receiving module is the same as a version of the removed component, and a deadline of storing the information about the removed component is different from current time.

19. A server, comprising:
a querying and obtaining module configured to query and obtain state information of a removed component or information about the removed component, wherein the information is set by a terminal; and
an operation determining module configured to determine operations to be performed for a subsequent component according to the state information of the removed component or the information about the removed component, wherein the information is obtained by the querying and obtaining module.

20. The server according to claim 19, wherein the operation determining module comprises:
a recommending submodule configured to: recommend installation of the subsequent component if the subsequent component is different from the removed component, or, if the subsequent component is the same as the removed component but version of the subsequent component is different from version of the removed component.

21. The server according to claim 19, wherein the operation determining module comprises:
a component information storing submodule configured to keep storing the information about the removed component if the version of the subsequent component is the same as the version of the removed component but a deadline of storing the information about the removed component is different from current time.
